(19) United States
(12) Patent Application Publication
(10) Pub. No.: US 2013/0106738 A1
(43) Pub. Date: May 2, 2013

(54) REMOTE CONTROLLER AND METHOD FOR OPERATING THE SAME

(71) Applicants: Beomjin KIM, Seoul (KR); Sora Cheon, Seoul (KR)

(72) Inventors: Beomjin KIM, Seoul (KR); Sora Cheon, Seoul (KR)

(73) Assignee: LG ELECTRONICS INC., Seoul (KR)

(21) Appl. No.: 13/545,547

(22) Filed: Jul. 10, 2012

(30) Foreign Application Priority Data
Nov. 2, 2011 (KR) 10-2011-0113422

(51) Int. Cl. G06F 3/041

(52) U.S. Cl. 345/173

(57) ABSTRACT

A remote controller including a touch screen and a method for operating the same are provided. The user can more conveniently and variously manage and use content and information by easily connecting electronic devices using a remote controller. The remote controller provides various user interfaces to increase user convenience.

### CROSS-REFERENCE TO RELATED APPLICATION

This application claims the benefit of Korean Application No. 10-2011-0113422, filed on Nov. 2, 2011 in the Korean Intellectual Property Office, the disclosure of which is incorporated herein by reference.

### BACKGROUND OF THE INVENTION

1. Field of the Invention

The present invention relates to a remote controller and a method for operating the same, and more particularly to a remote controller including a touch screen and a method for operating the same which can improve user convenience.

2. Description of the Related Art

Network technologies, which allow various electronic devices to be connected to each other, have been developed to allow users to always enjoy convenient, safe, economical daily-life services indoor and outdoor. In such a network, electronic devices such as a PC, a TV, a refrigerator, and a portable terminal are connected to each other to allow a variety of data to be shared and transmitted.

Along with such tendency, studies have been increasingly conducted on a remote controller that can provide a user interface environment for controlling a variety of electronic devices and functions.

### SUMMARY OF THE INVENTION

A method for operating a remote controller in accordance with one embodiment of the present invention includes displaying a home screen including objects indicating a plurality of controllable electronic devices on a display, receiving an input of touching a first object among the objects and dragging the first object to a second object, and transmitting a control signal for associated operation of electronic devices corresponding to the first and second objects.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates an example of a remote controller and controllable electronic devices according to an embodiment of the present invention;

FIG. 2 is a block diagram of a remote controller according to an embodiment of the present invention;

FIG. 3 illustrates examples of a remote controller;

FIG. 4 is a flowchart illustrating a method for operating a remote controller according to an embodiment of the present invention;

FIGS. 5 to 12 illustrate various examples of the remote controller operation method of FIG. 4;

FIG. 13 is a flowchart illustrating a method for operating a remote controller according to an embodiment of the present invention; and

FIGS. 14 to 17 are drawings used to explain a variety of examples of the remote controller operation method of FIG. 13.

### DETAILED DESCRIPTION OF THE PREFERRED EMBODIMENTS

The present invention will be described in more detail with reference to the attached drawings.

The words “module” or “unit”, which are appended to terms describing components, are merely used for ease of explanation of the present invention and have no specific meaning or function with respect to the components. Thus, the words “module” and “unit” may be used interchangeably.

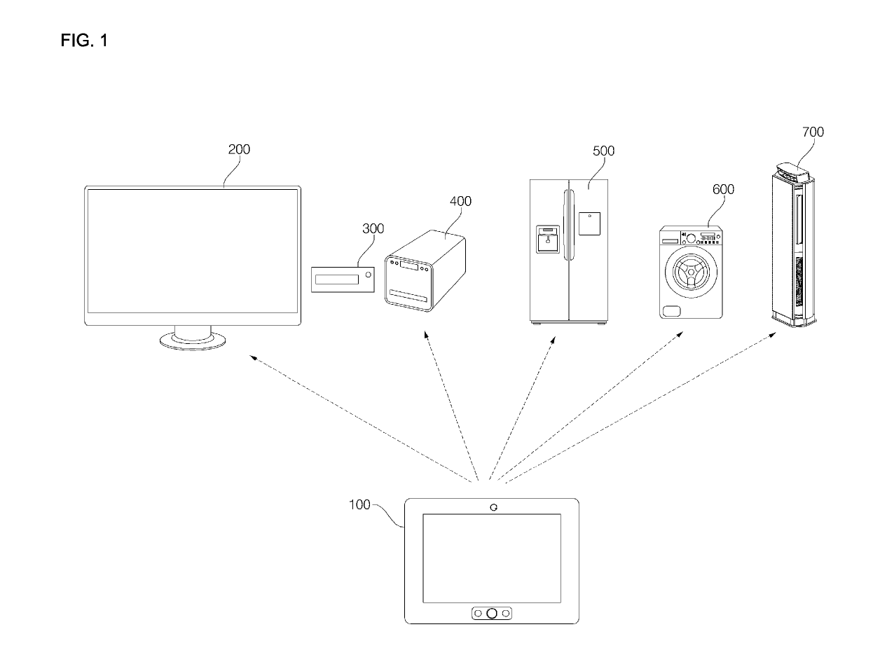

FIG. 1 illustrates an example of a remote controller and controllable electronic devices according to an embodiment of the present invention.

As shown in FIG. 1, a remote controller 100 according to an embodiment of the present invention may transmit or receive data to or from electronic devices according to a variety of communication standards such as an infrared scheme, an RF scheme, a Near Field Communication (NFC) scheme, ZigBee, or Digital Living Network Alliance (DLNA). The remote controller 100 may also be connected to a wired/wireless network including the Internet to transmit or receive data.

In addition, the remote controller 100 according to the present invention can control a plurality of electronic devices and can transmit a control signal to the electronic devices using an infrared scheme or an RF scheme.

In FIG. 1, an image display device 200, a set-top box (STB) 300, a network storage device 400, a refrigerator 500, a laundry processing device 600, and an air conditioner 700 are illustrated as examples of the electronic devices. Examples of the electronic devices may also include a cooking device, a home theater system, a camera, and a game console.

The remote controller 100 according to the present invention may also include a touch screen to provide a user interface and to enable touch input.

Examples of the remote controller include portable terminals such as a tablet PC, a mobile phone, a smart phone, a Personal Digital Assistant (PDA), a Portable Multimedia Player (PMP), and a digital broadcast terminal in which functions or applications capable of controlling electronic devices have been installed.

The remote controller 100 may exchange login information with other electronic devices such as the image display device 200, the STB 300, the network storage device 400, the refrigerator 500, the laundry processing device 600, and the air conditioner 700.

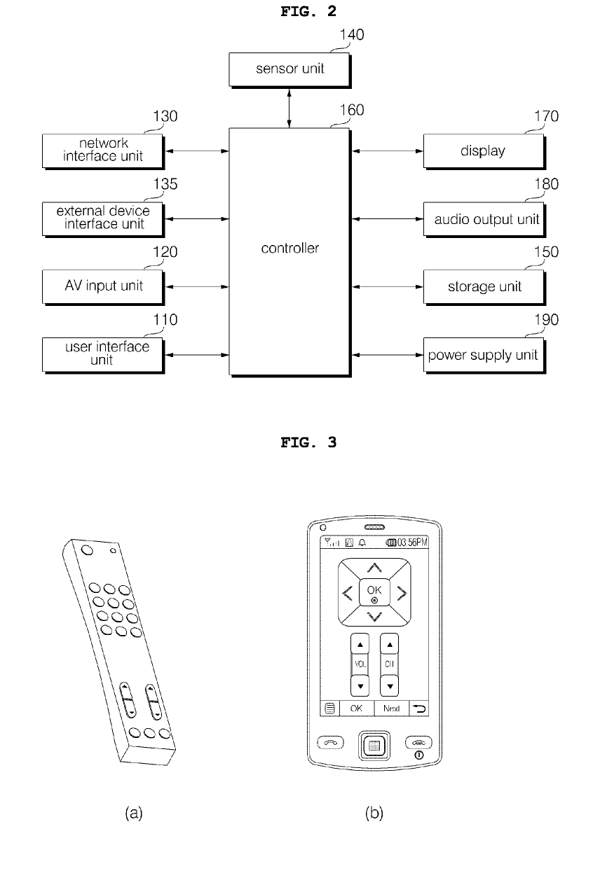

FIG. 2 is a block diagram of a remote controller according to an embodiment of the present invention.

As shown in FIG. 2, the remote controller 100 according to an embodiment of the present invention may include a user interface unit 110, an Audio/Video (AV) input unit 120, a network interface unit 130, an external device interface unit 135, a sensor unit 140, a storage unit 150, a controller 160, a display 170, an audio output unit 180, and a power supply unit 190.

In actual applications, two or more of these components may be combined into one component or one component may be divided into two or more components as needed.

The user input unit 110 generates key input data corresponding to a key input operation that a user has performed to control the operation of the communication terminal. The user input unit 110 may include a key pad, a switch, or a resistive or capacitive touchpad (touch screen) that can receive a command or information through a push or touch operation by the user. The user input unit 110 may also include a jog wheel, a joystick, a finger mouse, or the like.

The AV input unit 120, which is a device for receiving an audio signal or an image signal, may include a camera, a microphone, and the like. The audio signal or the image signal may be transmitted to the outside through the network interface unit 130 or the external device interface unit 135.

The microphone receives an external audio signal in a communication mode, a record mode, or a voice recognition mode and processes the same into audio data.

The network interface unit 130 provides an interface for connecting the remote controller 100 to a wired/wireless network including the Internet. For example, the network interface unit 130 may include an Ethernet terminal or the like for connecting to a wired network. The network interface unit 130 may use Wireless LAN (WEAN) (i.e., Wi-Fi), Wireless broadband (WiBro), World Interoperability for Microwave Access (WiMax), or High Speed Downlink Packet Access (HSDPA) for connection to a wireless network.

The network interface unit 130 may transmit or receive data to or from other users or other electronic devices through the connected network or another network linked to the connected network. Specifically, the remote controller 100 can transmit a control signal to each electronic device.

The network interface unit 130 may be network-connected to electronic devices such as a TV, a Digital Versatile Disc (DVD), a Bluray game console, a camera, a camcorder, a computer (or a laptop computer), and a refrigerator.

The network interface unit 130 may also connect to a webpage through the connected network or another network linked to the connected network. That is, the network interface unit 130 may connect to a webpage through a network to transmit or receive data to or from a corresponding server. The network interface unit 130 may also receive a plurality of data or content provided by a network operator or a content provider through a network. That is, the network interface unit 130 may receive content such as a movie, advertisement, game, VOD, or a broadcast signal and associated information, which are provided from a content provider or a network provider, through a network. The network interface unit 130 may also receive update information and update files of firmware provided by a network operator. The network interface unit 130 may also transmit a plurality of data to the Internet, a content provider, or a network operator.

The network interface unit 130 may select and receive a desired application from among applications, which are opened to the public, through a network. Specifically, the network interface unit 130 may select and receive applications for controlling other electronic devices.

The network interface unit 130 may include a mobile communication unit for connecting a mobile communication network and performing audio and video phone communication. The mobile communication unit transmits or receives a wireless signal to or from at least one of a base station, an external terminal, and a server through a mobile communication network. Examples of the wireless signal may include an audio call signal, a video call signal, or various types of data associated with transmission and reception of text/multimedia messages.

The remote controller 100 may receive a broadcast-related signal through a wired/wireless Internet network and may further include a separate broadcast receiver (not shown) for receiving broadcasts.

The broadcast receiver (not shown) may receive at least one of a broadcast signal and broadcast-related information from the outside and may include a tuner, a demodulator, a demultiplexer, a decoder, and the like for signal reception and processing. A broadcast signal and/or broadcast-related information received through the broadcast receiver (not shown) may be stored in the storage unit 150.

The external device interface unit 135 may connect the remote controller 100 to an external device. For this connection, the external device interface unit 135 may include an A/V input/output unit (not shown), a wireless communication unit (not shown), or the like.

The external device interface unit 135 may be connected by wire or wirelessly to an external device such as a TV, a Digital Versatile Disc (DVD), a Bluray game console, a camera, a camcorder, a computer (or a laptop computer), or a refrigerator. The external device interface unit 135 delivers a video, audio, or data signal received from the outside through the connected external device to the controller 160 of the remote controller 100. The external device interface unit 135 may also output a video, audio, or data signal processed by the controller 160 to the connected external device. To accomplish this, the external device interface unit 135 may include an A/V input/output unit (not shown) or a wireless communication unit (not shown).

To allow video and audio signals of an external device to be input to the remote controller 100, the A/V input/output unit may include a USB terminal, a Composite Video Banking Sync (CVBS) terminal, a component terminal, an S-video terminal (analog terminal), a Digital Visual Interface (DVI) terminal, a High Definition Multimedia Interface (HDMI) terminal, an RGB terminal, a D-SUB terminal, or the like.

The wireless communication unit may be network-connected to another electronic device according to a variety of communication standards, for example, Radio Frequency (RF), Bluetooth, Radio Frequency Identification (RFID), Infrared Data Association (IrDA), Ultra Wideband (UWB), ZigBee, Digital Living Network Alliance (DLNA), or the like.

The external device interface unit 135 may also function to interface not only with the external devices described above but also with all other external devices connected to the remote controller 100. Examples of the external devices connected to the remote controller 100 include a wired/wireless headset, an external charger, a wired/wireless data port, a card socket such as a memory card socket, a Subscriber Identification Module (SIM) card socket, or a User Identify Module (UIM) card socket, an audio Input/Output (I/O) terminal, a video I/O terminal, earphones, and the like. The external device interface unit 135 may receive power or data from such an external device and deliver the same to each component in the remote controller 100 and may also allow data present in the remote controller 100 to be transmitted to the external device.

The external device interface unit 135 may receive an application or an application list present in an adjacent external device and deliver the same to the controller 160 or the storage unit 150.

The controller 160 may transmit a user command or a control signal generated by a program to another electronic device connected through the network interface unit 130 or the external device interface unit 135 or may perform a command based on a control signal received from a permitted electronic device. For example, the controller 160 may perform a scheduled operation using a PC connected to a home network or may check items in a smart refrigerator or may receive a variety of signals such as a message or a command from a smart phone of a family member.

The sensor unit 140 detects current states of the remote controller 100 such as the position of the remote controller 100 and presence or absence of user contact upon the remote controller 100 and generates a sensing signal for controlling the operation of the remote controller 100.

The sensor unit 140 may include a detection sensor, a pressure sensor and a motion sensor. The detection sensor may detect an approaching object or whether an object is present near the remote controller 100 without mechanical contact. More specifically, the detection sensor may detect an approaching object based on change in an alternating current (AC) magnetic field or a static magnetic field, or the rate of change of capacitance. The sensing unit may also include two or more detection sensors depending on the form of implementation of the remote controller 100.

The pressure sensor may determine whether pressure is being applied to the remote controller 100 or may measure the magnitude of pressure, if any, applied to the remote controller 100. The pressure sensor may be installed in a certain part of the remote controller 100 where the detection of pressure is necessary, depending on the use environment of the remote controller 100. In the case in which the pressure sensor may be installed in the display 170, it is possible to differentiate a typical touch input from a pressure touch input, which is generated by applying greater pressure than that used to generate a typical touch input, based on a signal output by the pressure sensor. It is also possible to determine the magnitude of pressure applied to the display 170 upon receiving a pressure touch input based on the signal output by the pressure sensor.

The motion sensor may detect the location, motion, or the like of the remote controller 100 using an acceleration sensor, a gyro sensor, or the like. The acceleration sensor, which can be used for the motion sensor, converts acceleration in one direction into an electric signal. The gyro sensor may detect angular velocity and a rotated direction of the remote controller 100 relative to a reference direction and may sense information associated with operation of the remote controller 100 with respect to the x, y, and z axes. The acceleration sensor can sense information associated with movement speed or the like of the remote controller 100. In general, two-axis or three-axis acceleration sensors are incorporated into a single package. Only the z-axis acceleration sensor may be needed depending on the use environment of the sensor. Thus, when there is a need to use an x or y-axis acceleration sensor instead of the z-axis acceleration sensor, the x or y-axis acceleration sensor may be mounted on an additional substrate and the additional substrate may then be mounted on a main substrate.

The storage unit 150 may store a program, a platform, and an application for a variety of signal processing and control of the controller 160 and may also store video, audio, or data signals which have been subjected signal processing.

The remote controller 100 may play a content file (such as a video file, a photo file, a music file, a document file, an application file, etc.) stored in the storage unit 150 and provide the played signal to the user.

The storage unit 150 may also perform a function to temporarily store a video, audio, or data signal received from the external device interface unit 135 or the network interface unit 130.

The storage unit 150 may include a storage medium of at least one of a variety of types including a flash memory type, a hard disk type, a multimedia card micro type, a card memory type (for example, SD or XD memory), RAM, and ROM (for example, EEPROM).

Although FIG. 2 illustrates an example in which the storage unit 150 is provided separately from the controller 160, the scope of the present invention is not limited to this example. For example, the storage unit 150 may be included in the controller 160.

The controller 160 may control overall operation of the remote controller 100. For example, the controller 160 may control the remote controller 100 according to a user command received through the user interface unit 110 or an internal program. Specifically, the controller 160 may connect to a network to allow the user to download a desired application or application list to the remote controller 100.

The controller 160 may allow video or audio to be output through the display 170 or the audio output unit 180 based on a received signal.

In another example, the controller 160 may allow an image signal or an audio signal, which is received from an external device (for example, a camera or a camcorder) through the external device interface unit 135, to be output through the display 170 or the audio output unit 180 according to a video play command received from an external device through the user interface unit 110.

In a video communication mode, the controller 160 may control the display 170 to display an image of a communication counterpart and an image of the user according to user settings and may control the audio output unit 180 to output audio based on a received audio signal of the communication counterpart. The controller 160 may also determine whether or not a touch input is a character input such as alphabet, number, or letter based on a pattern of the touch input signal. The controller 160 may check a character corresponding to trajectory of the touch input based on a database. The database may include Korean, English, Chinese, Japanese, numbers, symbols, and the like and may be stored in the controller 160 or the storage unit 150.

The controller 160 may display a character corresponding to the pattern of a touch input on the display 170 using stored font or may also process a touch input as a handwriting input to display the trajectory of the touch input.

The controller 160 may also perform a control operation to install or run an application downloaded from an external network in conjunction with various user interfaces. In addition, the controller 160 may control the display 170 to display an image associated with an executed application according to user selection.

An arbitrary platform of the remote controller 100 according to the embodiments of the present invention may include OS-based software in order to perform various operations described above. The platform may be provided in the controller 160 or in a separate processor in the form of a program or may be stored in the storage unit 150.

An arbitrary platform of the remote controller 100 according to the embodiments of the present invention may include an OS kernel, a driver on an OS kernel, middleware, a framework, or an application.

The OS kernel may be implemented through a kernel based on various OSs such as Window-based OS. The OS kernel may also be an open OS kernel, i.e., a general purpose OS kernel that can be used in other electronic devices or the like.

The display 170 may convert a data signal or an image signal processed by the controller 160 or a data signal or an image signal received from the network interface unit 130 or the external device interface unit 135 into an RGB signal and generate a corresponding drive signal.

The display 170 may be a PDP, a liquid crystal display (LCD), an organic light-emitting diode (OLED), a flexible display, a 3D display, or the like.

The display 170 may be constructed of a touch screen and may be used as an input device in addition to an output device.

The audio output unit 180 outputs audio data received or stored in a call signal reception mode, a communication mode, a record mode, a voice recognition mode, a broadcast reception mode, or the like. The audio output unit 180 also outputs an audio signal associated with functions performed by the remote controller 100, for example, an audio signal associated with call reception sound or effects sound. The audio output unit 180 may include a speaker, a buzzer, or the like.

The power supply unit 190 supplies corresponding power to each component of the remote controller 100.

The remote controller 100 described above with reference to FIG. 2 may be constructed so as to be operable in communication systems in which data can be transmitted through frames or packets, the systems including a wired/wireless communication system and a satellite-based communication system.

FIG. 3 illustrates examples of a remote controller that controls a plurality of electronic devices. Specifically, FIG. 3(a) illustrates a universal remote controller that controls a plurality of devices using IR key values corresponding to the plurality of devices and FIG. 3(b) illustrates a smart phone in which applications for controlling electronic devices are installed.

The universal remote controller provides many universal remote control functions. The universal remote controller uses IR key values to control each device. Alternatively, the user registers a device to be used in the universal remote controller, for example, using a stored IR key value, and then enters a device selection menu to select the device and then uses the universal remote controller as a single remote controller to control the device.

One advantage of the universal remote controller is a macro function which allows the user to simultaneously control a plurality of devices using a single button. However, it is difficult for a general user to set the macro function and it is also inconvenient to use the macro function. Therefore, only few consumers use hybrid control through the macro function.

In addition, when the macro function has been set, it is difficult for others than the user to use the macro function since others than the user cannot identify the macro function.

Even the mobile terminal which can control electronic devices as shown in FIG. 3(b) does not sufficiently provide hybrid remote control functions since the mobile terminal uses dedicated applications of devices and also provides respective control UIs of devices.

A method for operating a remote controller that solves such problems is described below in detail with reference to the drawings.

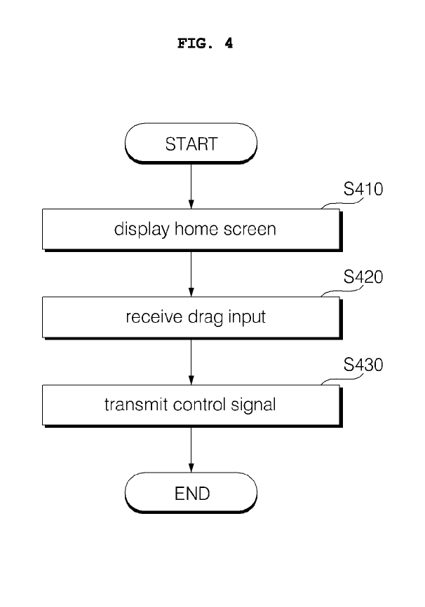

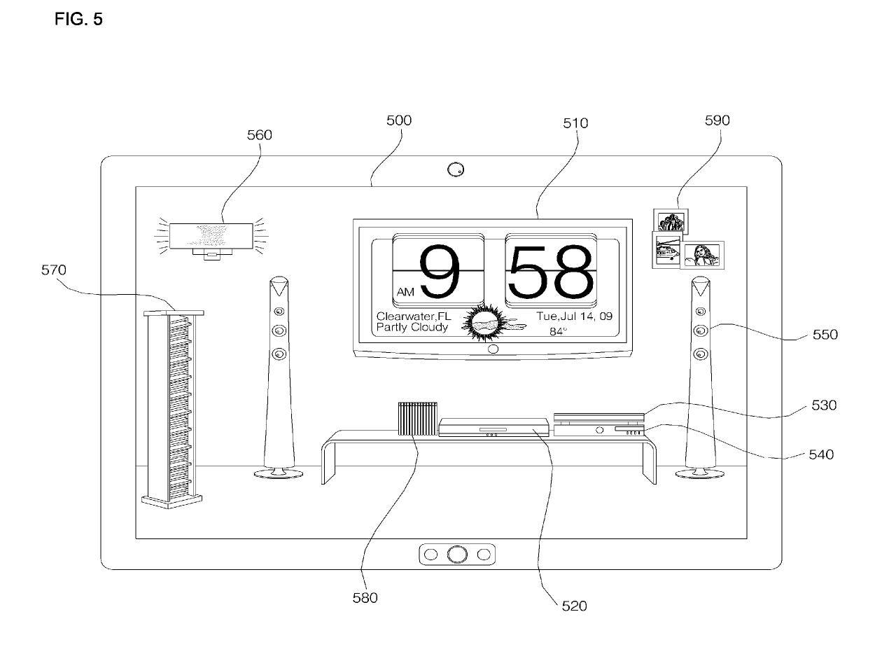

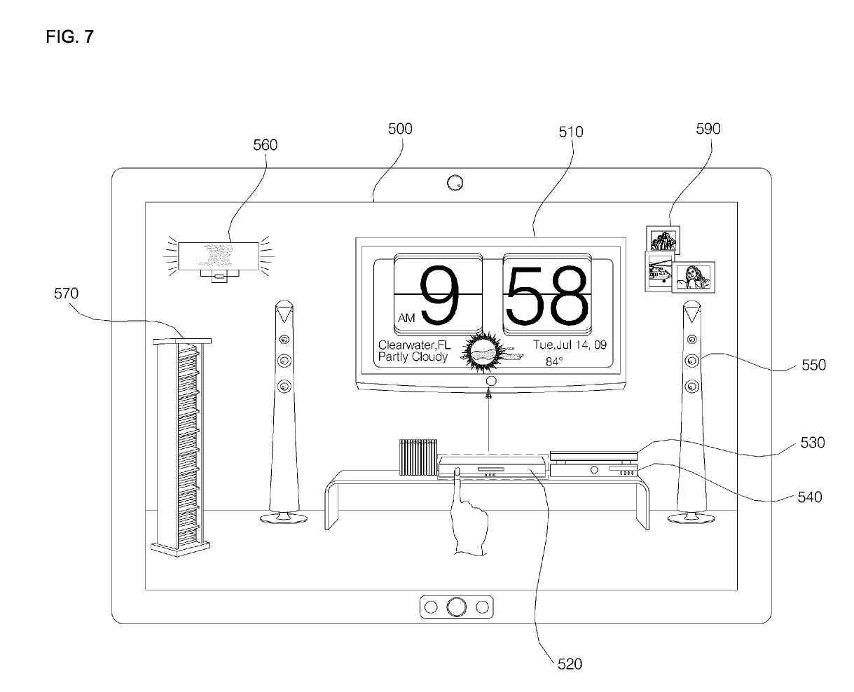

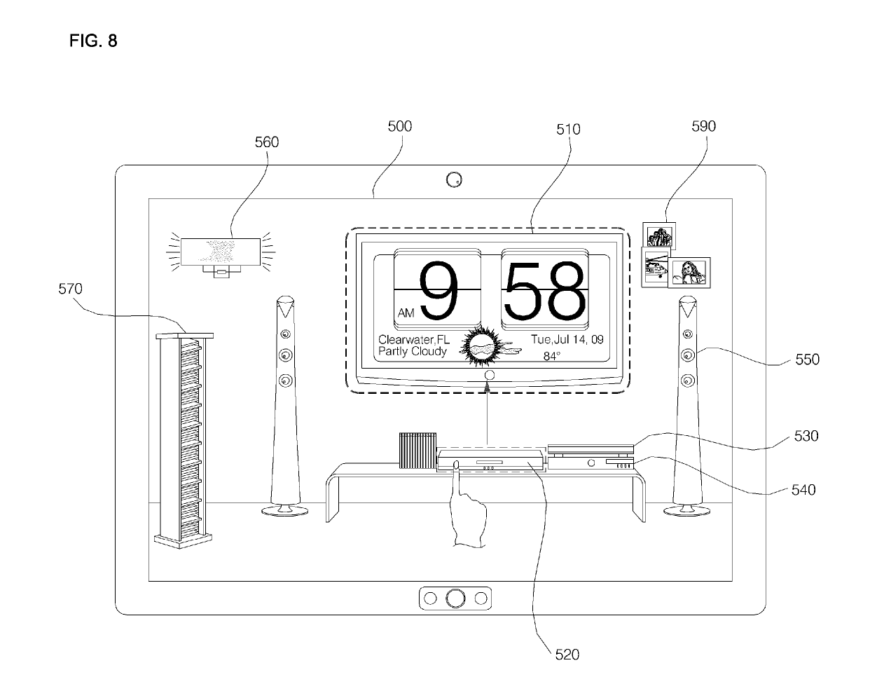

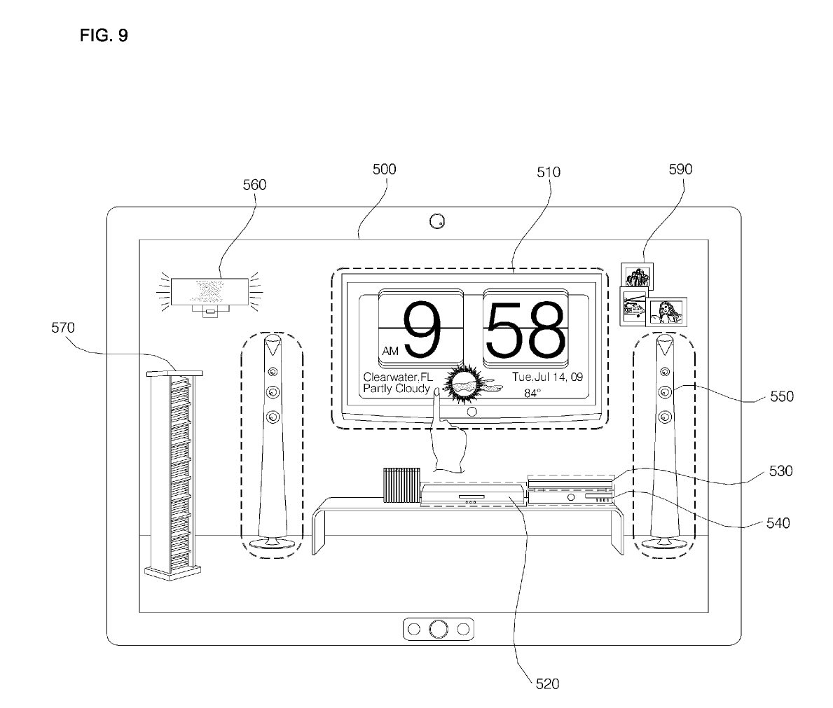

FIG. 4 is a flowchart illustrating a method for operating a remote controller according to an embodiment of the present invention and FIGS. 5 to 12 illustrate various examples of the remote controller operation method of FIG. 4.

As shown in FIG. 4, first, the remote controller 100 displays a home screen including objects indicating a plurality of controllable electronic devices on the display 170 (S410).

Specifically, when the remote controller 100 is powered on or when an application for controlling the plurality of electronic devices is executed, a home screen 500 including objects 510, 520, 530, 540, 550, and 560 indicating a plurality of controllable electronic devices may be displayed on the display 170 as shown in FIG. 5.

The objects 510, 520, 530, 540, 550, and 560 arranged on the home screen may correspond to electronic devices to be controlled and the electronic devices may have been set according to communication and network environments in each residence.

The controllable electronic devices displayed on the home screen 500 shown in FIG. 5 may include a TV 510, an optical disc player 520, for example, a Bluray Disc Player (BDP), a set-top box (STB) 530, an audio/video receiver (AVR) 540, a speaker 550, and a digital lighting device 560. The controllable electronic devices may also include other electronic devices such as a game console, a PC, and a laptop computer which are not illustrated in FIG. 5. The AVR 540, an amplifier, and the speaker 550 may be constructed as an integral unit and the amplifier and the speaker 550 may be controlled through the AVR 540.

The home screen 500 may also include objects corresponding to content, which can be used on an electronic device, such as music content 570, a video title 580 such as a DVD or a Bluray disc (BD), and a photograph 590.

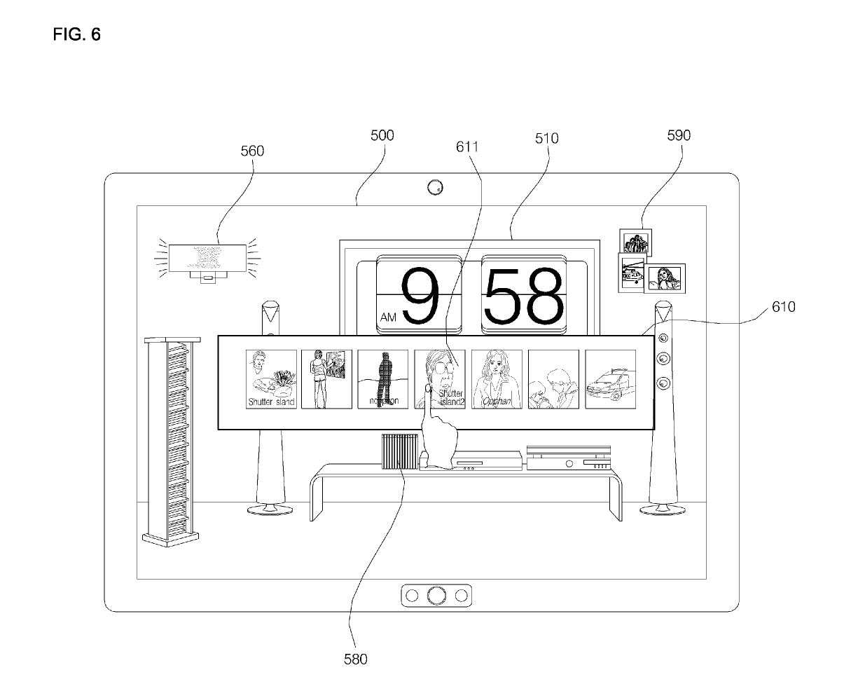

When the user touches the music content 570 or the video title 580, reproducible content items 610 may be displayed in the form of a list or graphic objects as shown in FIG. 6.

The user may reproduce a desired content item 611 by selecting and dragging the content item 611 to the TV 510, the player 520, or the AVR 540.

The controller 160 may receive an input of touching the first object 520 among the plurality of objects included in the home screen 500 and dragging the first object 520 to the second object 510 (S420). The controller 160 may receive the drag input through the user interface unit 110.

In this case, the controller 160 may change a display state of the touched first object 520. That is, the controller 160 may change at least one of a size, color, transparency, and shape of the first object 520 selected by touch or may impart a graphic effect such as a highlight to the first object 520 to allow the user to intuitively determine that the first object 520 has been selected.

The controller 160 may also change a display state of each object based on whether or not an electronic device corresponding to the object can be associated with the electronic device corresponding to the touched first object 520.

When the first object 520 corresponding to the optical disc player has been selected, the controller 160 may change a display state of the object 510 corresponding to the TV which may operate in connection with the optical disc player. This allows the user to intuitively identify an electronic device with which the selected object can operate in connection before completing the drag input.

In addition, when the object 510 corresponding to the TV has been touched, the controller 160 may change display states of the optical disc device 520, the STB 530, the AVR 540, and the speaker 550 which can operate in connection with the TV 510.

The display state of the touched first object 520 may be different from the display states of the objects corresponding to the electronic devices which may be associated with the electronic device corresponding to the first object 520.

The controller 160 may also change a display state of an object corresponding to an electronic device which cannot operate in connection with an electronic device corresponding to an object selected by touch. For example, the controller 160 may shade or demagnify such an electronic device.

The controller 160 may also deactivate an object corresponding to an electronic device which cannot operate in connection with an electronic device corresponding to an object selected by touch.

In the drawings, such a change of the display state of the first object 520 is shown by a dotted line around the first object 520 for ease of explanation. The electronic devices which can operate in association with the specific electronic device are merely an example and the present invention is not limited to the example.

The controller 160 then transmits a control signal for associated operation of the electronic devices corresponding to the first object and the second object (S430). The controller 160 may transmit a control signal to electronic devices through the wireless communication unit (not shown) included in the external device interface unit 135 as described above with reference to FIG. 2.

That is, the controller 160 transmits the control signal for associated operation to the TV 510 and the optical disc device 520.

The control signal for associated operation may include a control signal for connecting the electronic device corresponding to the first object to an input or output of the electronic device corresponding to the second object.

The control signal for associated operation may also include a signal for powering the electronic devices on or a signal for releasing a standby mode of each electronic device.

For example, when the user desires to connect the optical disc player (for example, a BDP) to the TV to view a BD title on the BDP, the user may perform an input of dragging and dropping the BDP onto the TV after selecting the BDP. This allows the controller 160 to power the TV and the BDP on and to perform a hybrid operation in which an input of the TV is matched with (or adjusted to) the BDP.

In addition, when the user desires to output sound of the image display apparatus (TV) to the AVR 540, the user may perform an input of dragging and dropping the TV 510 onto the AVR 540 after selecting the TV 510. This allows the controller 160 to perform a hybrid associated operation in which sound of the TV, i.e., the sound output of the TV, is transferred to (or converted to a signal corresponding to) the AVR. That is, the sound input of the AVR is set to the TV.

When one of the TV 510 or the AVR 540 is off or is in a standby mode, the controller 160 may perform a subsequent operation after activating the electronic device by transmitting a power-on signal for turning the electronic device on or a signal for releasing the standby mode.

The control signal for associated operation may also include a signal for network-connecting the electronic device corresponding to the first object to the electronic device corresponding to the second object. In this case, the controller 160 may transmit and receive network setting information, login information, device information, and the like to and from the electronic devices.

The control signal may be transmitted and received to and from each electronic device using a communication scheme such as IR, RF, or ZigBee which is compatible with the electronic device. When a communication signal such as an IR signal which is restrictive in directionality is used, the communication signal may be transmitted via an electronic device including a blaster or having a blaster function.

According to an embodiment of the present invention, the method may further include receiving an input of touching a third object among objects indicating the plurality of electronic devices and dragging the third object to a first object or a second object, and transmitting a control signal for associated operation between an electronic device corresponding to the third object and the electronic devices corresponding to the first and second objects.

That is, the user may additionally connect an electronic device to one of the first and second objects corresponding to the electronic devices, which have already been connected, by dragging and dropping an object corresponding to the electronic device, which is to be additionally connected, to one of the first and second object. Thus, the user can connect an additional electronic device to the two electronic devices.

For example, when the user desires to connect three devices, a TV, a BDP, and an AVR, the user may connect the TV and the BDP and then select the AVR and drag and drop the AVR to one of the TV and the BDP.

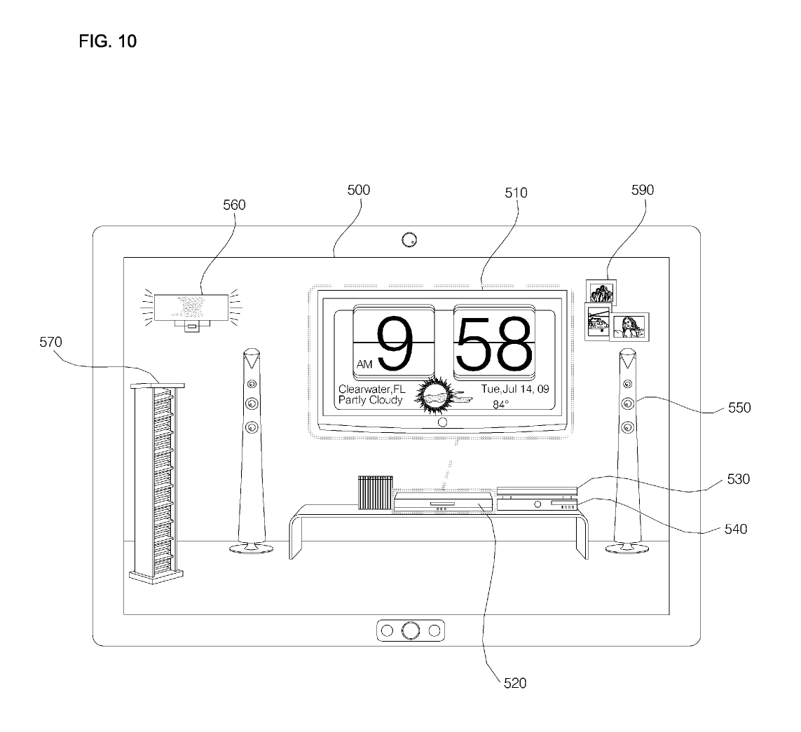

The method of operating a remote controller according to an embodiment of the present invention may further include displaying an object indicating an association state of the plurality of electronic devices, for example, a graphic object in the form of a line, as shown in FIG. 10. The graphic object may have a different color from objects indicating electronic devices to improve visibility of the graphic object.

The method may further include switching to a screen including the first and second objects and objects 1130 and 1140 indicating electronic devices which can be associated with the electronic devices corresponding to the first and second objects. In this case, a connection state of the electronic devices may be indicated by a graphic object in the form of a line.

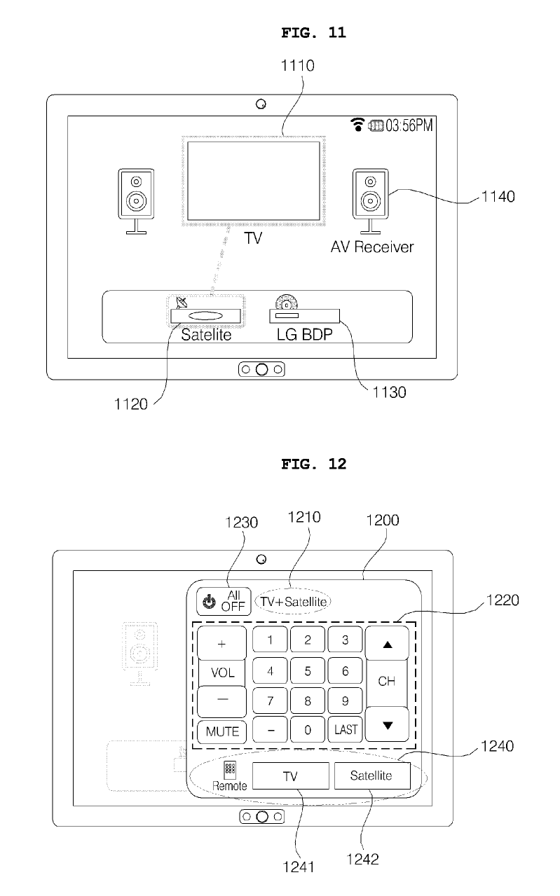

In an example of FIG. 11, objects 1110 and 1120 corresponding to a TV and a satellite broadcast STB which are connected to each other are displayed and objects 1130 and 1140 indicating electronic devices which can be associated with (or can operate in association with) the TV and the satellite broadcast STB are also displayed.

That is, a screen including objects corresponding to electronic devices which have already been connected and electronic devices which may be additionally connected to the electronic devices may be provided to the user.

Alternatively, it is also possible to switch to a screen including only the objects 1110 and 1120 corresponding to the electronic devices which have already been connected.

In this case, the method according to the present invention may further include receiving an input of selecting one of the first and second objects and displaying a user interface (UI) including a menu for controlling the electronic devices corresponding to the first and second objects.

When an input of touching each electronic device is received, the controller 160 may display a menu for controlling the touched electronic device. Thus, the displayed UI may include a dedicated menu for controlling the electronic device that the user has selected through the touch input.

When an input of touching the first object is received, the controller 160 may display a menu for controlling an electronic device corresponding to the first object, i.e., a dedicated UI of the selected electronic device.

As shown in FIGS. 12, 14, and 15, the UI may be a universal UI including a menu that enables universal control of the selected electronic devices, the menu being generated by combining respective dedicated UIs of the selected electronic devices.

Thus, the menu displayed as the user performs an input of touching an electronic device may be a universal menu or a dedicated menu of the electronic device touched by the user.

As described above, when the user tabs one of two electronic devices which have been connected, the controller 160 may output a universal UI (for example, a hybrid remote control menu) suitable for the connected electronic devices on a portion of the display 170.

FIG. 12 illustrates a universal UI.

The universal UI 1200 may include connected electronic device information 1210 and command menus 1220 and 1230 that enables the user to control connected electronic devices. The universal UI 1220 may also include menus 1240 for calling a dedicated UI of each device. Here, when a TV 1241 is selected, a dedicated screen remote controller for the TV may be additionally displayed, and, when an STB 1241 is selected, a dedicated screen remote controller for the STB may be additionally displayed.

The universal UI including a menu that enables universal (or united) control of electronic devices corresponding to the first and second objects may be directly displayed on the home screen.

The universal UI may also be displayed when one of the controllable electronic devices whose objects are included in the home screen, for example, one of the TV 510, the optical disc player 520 (for example, the Bluray Disc Player (BDP)), the STB 530, the AVR 540, the speaker 550, and the digital lighting device 560, is selected through a touch input.

The universal UI will be described later in more detail.

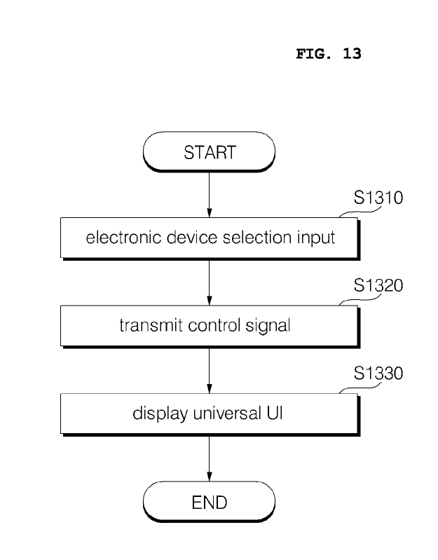

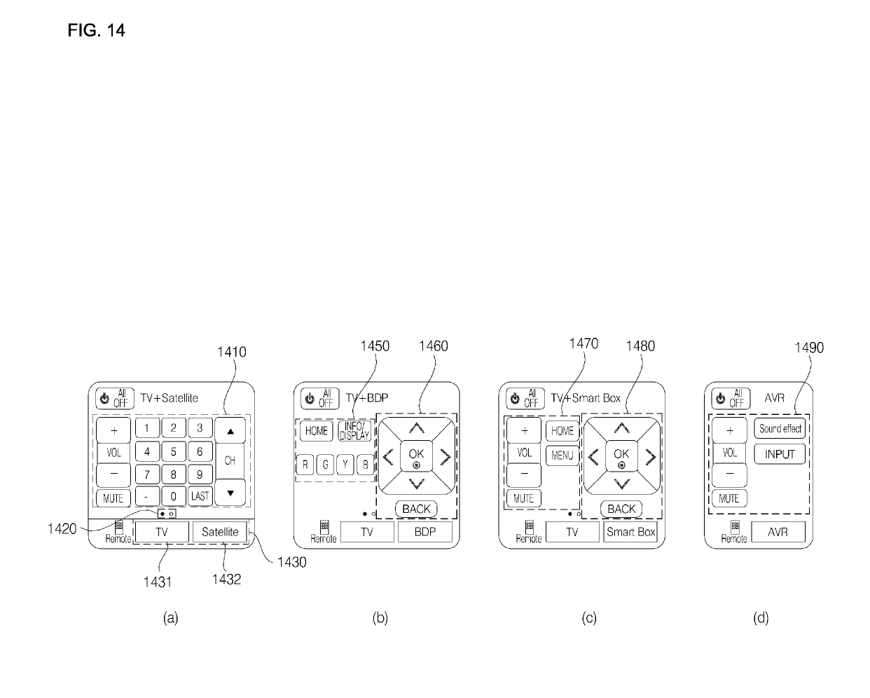

FIG. 13 is a flowchart illustrating a method for operating a remote controller according to an embodiment of the present invention and FIGS. 14 to 17 are drawings used to explain a variety of examples of the remote controller operation method of FIG. 13.

As shown in FIG. 13, the controller 160 receives an input of selecting two or more electronic devices among a plurality of controllable electronic devices (S1310) and transmits a control signal for associated operation of the selected electronic devices to the selected electronic devices (S1320).

The selection input may be a drag input performed upon the home screen that has been described with reference to FIGS. 3 to 12.

The control signal for associated operation may include a control signal for connecting at least one of the selected electronic devices to an input or output of another electronic device and may also include a power-on signal for powering the electronic devices on or a signal for releasing a standby mode of each electronic device.

The control signal for associated operation may also include a signal for network-connecting the selected electronic devices.

The controller 160 then displays a UI including a menu that enables the user to control the selected electronic devices on the display 170 (S1330).

When an input of touching each electronic device is received, the controller 160 may display a menu for controlling the touched electronic device. Thus, the displayed UI may include a dedicated menu for controlling the electronic device that the user has selected through the touch input.

As shown in FIGS. 12, 14, and 15, the UI may be a universal UI including a menu that enables universal control of the selected electronic devices, the menu being generated by combining respective dedicated UIs of the selected electronic devices.

Thus, the menu displayed as the user performs an input of touching an electronic device may be a universal menu or a menu of the electronic device touched by the user.

The UI display step S1330 may include displaying the UI on a portion of the display 170. For example, the controller 160 may display a universal UI in a popup form on the screen of FIG. 12.

The universal UI may be generated by combining respective dedicated UIs of the selected electronic devices.

FIG. 14 illustrates a variety of examples of the universal UI.

FIG. 14(a) illustrates a universal UI generated when the TV and the satellite broadcast STB are connected.

The universal UI 1400 may include connected electronic device information and command menus 1410 that enable control of the connected electronic devices.

FIG. 14(b) illustrates a universal UI generated when the TV and the optical disc player are connected and FIG. 14(c) illustrates a universal UI generated when the TV and a smart box are connected. The smart box may include functions of a network storage device.

From FIGS. 14(a) to 14(c) which illustrate examples in which universal menus are displayed when the TV is connected to other electronic devices, it can be seen that different menus are displayed according to the electronic devices connected to the TV.

Some 1460 and 1480 of the menus 1450 and 1460 that enable universal (or united) control of the TV and the optical disc player and the menus 1470 and 1480 that enable universal control of the TV and the smart box may be identical or may include an identical portion.

Accordingly, according to the present invention, a universal UI that not only supports an individual operation of each electronic device but also includes respective remote control menus suitable for connected electronic devices when two or more electronic devices are controlled is provided to give intuition to the user and a home interface environment (home GUI) is provided to increase user understanding.

As shown in FIG. 14(a), the universal UI may include menus 1430 for displaying respective dedicated UIs of the selected electronic devices.

The method may further include receiving an input performed upon one of the menus for displaying the respective dedicated UIs of the selected electronic devices and additionally displaying the dedicated UI of the electronic device upon which the input has been performed.

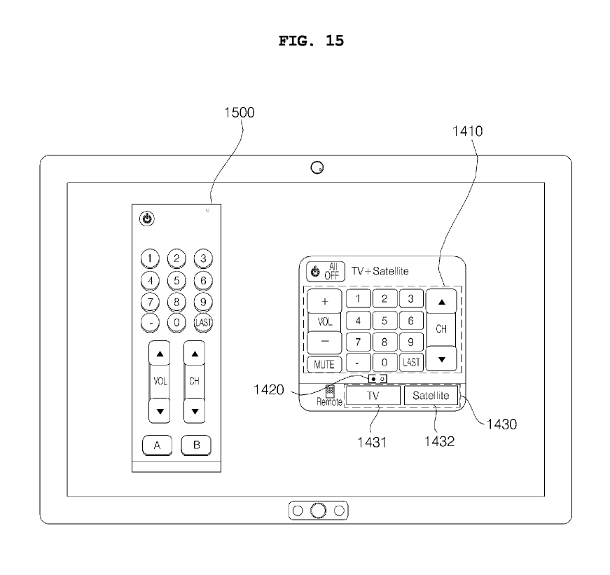

When a TV menu 1431 among the menus for displaying the respective dedicated UIs of the selected electronic devices is selected, a dedicated screen remote controller 1500 for the TV is additionally displayed as shown in FIG. 15. When the STB 1432 is selected, a dedicated screen remote controller for the STB may be additionally displayed.

The universal UI may include an object 1420 indicating page information when other menus which are not displayed on the screen are present and the menus 1430 for displaying the respective dedicated UIs of the selected electronic devices.

An input, which includes an input of sliding to the left or to the right, may be performed to switch to a left or right page to view other menus. Accordingly, a method for operating a remote controller according to an embodiment of the present invention may include receiving a slide input performed upon the universal UI and switching the universal UI to another page based on direction of the slide input.

According to an embodiment, as shown in FIG. 12, the method may further include displaying objects indicating the selected electronic devices and receiving an input of selecting one of the objects indicating the selected electronic devices. In this case, the controller 160 may display the UIs.

When an input of touching a portion other than the portion on which the universal UI is displayed is received, the controller 160 may terminate display of the universal UI.

That is, when an electronic device is tabbed on the screen of FIG. 11, the screen may be switched to the screen of FIG. 12 and, when a portion of the screen of FIG. 12 on which the universal UI is not displayed is tabbed, the screen of FIG. 12 may be switched to the screen of FIG. 11. Here, since the screen of FIG. 11 is an exemplary home screen displayed after a plurality of devices is connected, the screen of FIG. 12 may be switched to the home screen of FIG. 5.

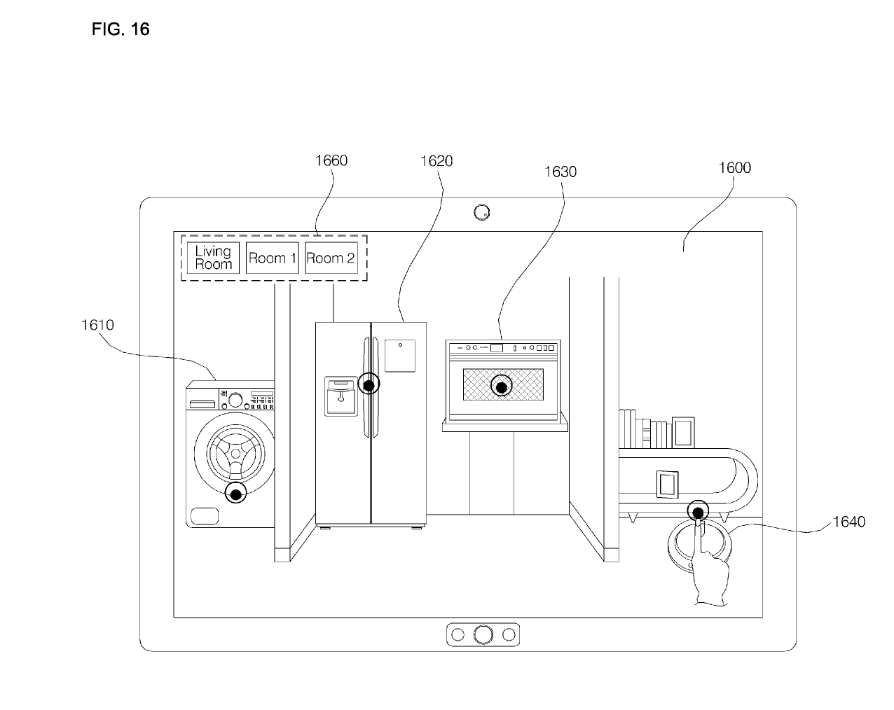

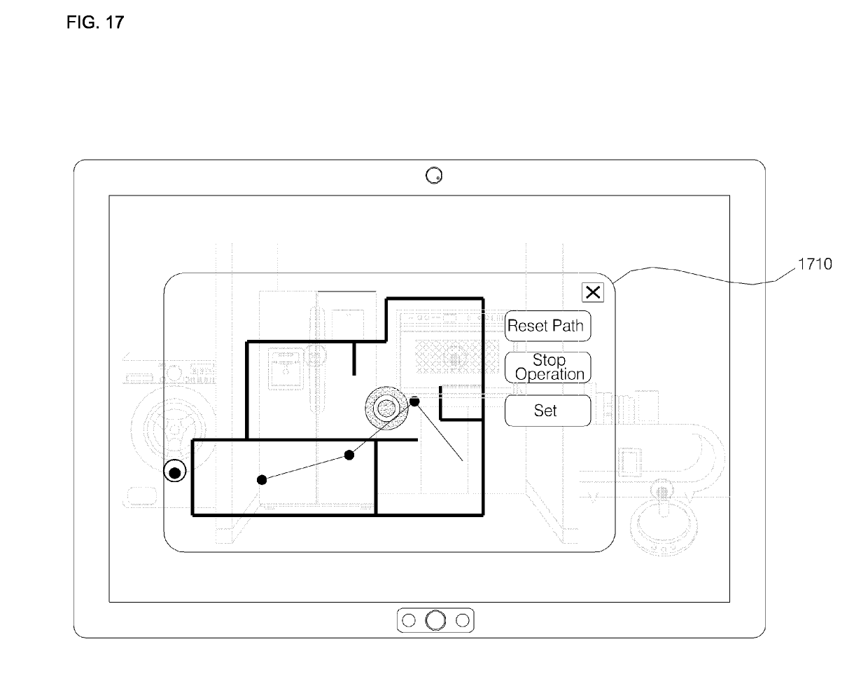

FIG. 16 and FIG. 17 illustrate another example of the present invention.

As shown in FIGS. 16 and 17, a home screen 1600 may include menus 1660 that enables switching to menus and objects of electronic devices of another group. For example, as shown in FIG. 16, the electronic devices may be classified and grouped based on positions such as a living room, room 1, and room 2.

The home screen 1600 may include objects 1610, 1620, 1630, and 1640 corresponding to a plurality of controllable electronic devices (a washing machine, a refrigerator, a cooking device, and a cleaner).

One or more of the plurality of devices may be selected and a menu 1710 that enables the user to control operation of the selected electronic device may be displayed.

It is an object of the present invention to provide a remote controller including a touch screen and a method for operating the same which can improve user convenience.

It is another object of the present invention to provide a remote controller including a touch screen and a method for operating the same which allows the user to conveniently control a plurality of electronic devices.

A method for operating a remote controller in accordance with one embodiment of the present invention in order to achieve the objects includes displaying a home screen including objects indicating a plurality of controllable electronic devices on a display, receiving an input of touching a first object among the objects and dragging the first object to a second object, and transmitting a control signal for associated operation of electronic devices corresponding to the first and second objects.

A method for operating a remote controller in accordance with one embodiment of the present invention in order to achieve the objects includes receiving an input of selecting two or more electronic devices among a plurality of controllable electronic devices, transmitting a control signal for associated operation of the selected electronic devices, and displaying a user interface including a menu that enables control of the selected electronic devices.

The remote controller and the method for operating the same according to the present invention are not limited in application to the configurations and methods of the embodiments described above and all or some of the embodiments may be selectively combined to implement various modifications.

The method for operating the same according to the present invention can be embodied as processor readable code stored in a processor readable medium provided in the remote controller. The processor readable medium includes any type of storage device that stores data which can be read by a processor. Examples of the processor readable medium include Read Only Memory (ROM), Random Access Memory (RAM), CD-ROMs, magnetic tapes, floppy disks, optical data storage devices, and so on. The processor readable medium can also be embodied in the form of carrier waves such as signals transmitted over the Internet. The processor readable medium can also be distributed over a network of coupled processor systems so that the processor readable code is stored and executed in a distributed fashion.

Although the present invention has been illustrated and described above with reference to the specific embodiments, the present invention is not limited to the specific embodiments and it will be apparent to those skilled in the art that various modifications can be made to the embodiments without departing from the scope of the present invention as disclosed in the accompanying claims and such modifications should not be construed as departing from the spirit or scope of the present invention.

What is claimed is:

1. A method for operating a remote controller, the method comprising:
displaying a home screen including objects indicating a plurality of controllable electronic devices on a display;
receiving an input of touching a first object among the objects and dragging the first object to a second object; and
transmitting a control signal for associated operation of electronic devices corresponding to the first and second objects.

2. The method according to claim 1, further comprising changing a display state of the touched first object.

3. The method according to claim 1, further comprising changing a display state of each object based on whether or not an electronic device corresponding to the object can be associated with the electronic device corresponding to the touched first object.

4. The method according to claim 1, further comprising:
receiving an input of touching a third object among the objects indicating the plurality of electronic devices and dragging the third object to the first object or the second object; and
transmitting a control signal for associated operation of the electronic device corresponding to the third object and the electronic devices corresponding to the first and second objects.

5. The method according to claim 1, further comprising displaying an object indicating an associated state of the plurality of electronic devices.

6. The method according to claim 1, further comprising displaying a universal user interface including a menu that enables universal control of the electronic devices corresponding to the first and second objects.

7. A method for operating a remote controller, the method comprising:
receiving an input of selecting two or more electronic devices among a plurality of controllable electronic devices;
transmitting a control signal for associated operation of the selected electronic devices; and
displaying a user interface including a menu that enables control of the selected electronic devices.

8. The method according to claim 7, wherein the user interface is a universal user interface including a menu that enables universal control of the selected electronic devices, the menu being generated by combining respective dedicated user interfaces of the selected electronic devices.

9. The method according to claim 7, wherein the user interface includes a menu that enables display of respective dedicated user interfaces of the selected electronic devices.

10. The method according to claim 7, further comprising displaying objects indicating the selected electronic devices.

11. A remote controller comprising:
an external device interface unit;
a display for displaying a home screen including objects indicating a plurality of controllable electronic devices;
a user interface unit for receiving an input of touching a first object among the objects and dragging the first object to a second object; and
a controller for controlling the external device interface unit to transmit a control signal for associated operation of electronic devices corresponding to the first and second objects.

12. The remote controller according to claim 11, wherein the controller controls the display to change a display state of the touched first object.

13. The remote controller according to claim 11, wherein the controller controls the display to change a display state of each object based on whether or not an electronic device corresponding to the object can be associated with the electronic device corresponding to the touched first object.

14. The remote controller according to claim 11, wherein, when an input of touching a third object among the objects indicating the plurality of electronic devices and dragging the third object to the first object or the second object is received through the user interface unit, the controller controls the wireless communication unit to transmit a control signal for associated operation of the electronic device corresponding to the third object and the electronic devices corresponding to the first and second objects.

15. The remote controller according to claim 11, wherein an object indicating an associated state of the plurality of electronic devices is displayed on the display.

16. The remote controller according to claim 11, wherein the display displays a universal user interface including a menu that enables universal control of the electronic devices corresponding to the first and second objects.

17. A remote controller comprising:
a display;
a user interface unit for receiving an input of selecting two or more electronic devices among a plurality of controllable electronic devices;
an external device interface unit for transmitting a control signal for associated operation of the selected electronic devices; and
a controller for controlling the display to display a user interface including a menu that enables control of the selected electronic devices.

18. The remote controller according to claim 17, wherein the user interface is a universal user interface including a menu that enables universal control of the selected electronic devices, the menu being generated by combining respective dedicated user interfaces of the selected electronic devices.

19. The remote controller according to claim 17, wherein the user interface includes a menu that enables display of respective dedicated user interfaces of the selected electronic devices.

20. The remote controller according to claim 17, wherein the display displays objects indicating the selected electronic devices.
